(19) United States
(12) Patent Application Publication
(10) Pub. No.: US 2025/0087117 A1
(43) Pub. Date: Mar. 13, 2025

(54) LABEL FOR HISTOLOGY CASSETTE AND LABELLING METHOD

(71) Applicant: 13652611 CANADA INC., Laval (CA)

(72) Inventors: Gourgen AMBARTSOUMIAN, Laval (CA); John WAGNER, Laval (CA)

(21) Appl. No.: 18/825,292

(22) Filed: Sep. 5, 2024

Related U.S. Application Data
(60) Provisional application No. 63/581,713, filed on Sep. 11, 2023.

(51) Int. Cl. G09F 3/02; B65C 1/02; C09J 5/00; C09J 7/29; G01N 1/36; G09F 3/10

(52) U.S. Cl. CPC G09F 3/02883; B65C 1/02; C09J 5/00; C09J 7/29; G01N 1/36; G09F 3/10; C09J 2203/334; C09J 2301/16; G09F 2003/0226; G09F 2003/0264; G09F 2003/0272

(57) ABSTRACT

A label for tissue embedding cassette may have a facestock configured to have data on a first surface thereof. An adhesive layer is on a second surface of the facestock. Slits are defined in the facestock from an edge thereof, the slits defining at least one tab, the at least one tab configured to be located opposite a female connector in a box of the tissue embedding cassette when the label is adhered to a slanted surface of the tissue embedding cassette. The at least one tab forms a flap movable into the female connector by pressure of a male connector of a lid of the tissue embedding cassette when the male connector penetrates the female connector.

### CROSS-REFERENCE TO RELATED APPLICATION

The present application claims the priority of U.S. Patent Application No. 63/581,713, filed on Sep. 11, 2023, the contents of which are incorporated herein by reference.

### TECHNICAL FIELD

The present application relates to labels for use with tissue processing and embedding cassettes of the type used in pathology, cytology, histology, etc.

### BACKGROUND OF THE INVENTION

Tissue processing cassettes, also known as tissue embedding cassettes, are regularly used in pathology, cytology and histology labs and other labs for tissue sample fixation and processing for microscopy. For example, they may be available as Simport M385, M480, M481, M482, M485, M490, M492, M507, M508, M512, M517, M521, or similar commercially available from number of vendors worldwide. In a typical procedure, excised tissue is placed in a tissue embedding cassette for processing, starting with fixation. Fixation is used to preserve tissues and is usually carried out immediately or rapidly after the removal of the tissue to avoid tissue degradation. Once fixed, the tissue requires processing to convert it into a form that can be cut into thin microscopic sections, for instance by dehydration and clearing. Once processed, the tissue may be embedded in a substrate, such as paraffin wax, for the subsequent cutting of sections.

In an embodiment, dehydration of tissues may be achieved using an alcohol gradient in excess of 70%. Once the tissue is dehydrated, it may be cleared by removing the dehydrant with a compound that is also mixable with the paraffin which is used for embedding. Common clearing agent are solvents, such as xylene, toluene, limonene or others including substitutes for various solvents. There consequently is a difficulty in identifying and/or labelling tissue embedding cassettes, due to the effect of solvents on various label components including inks, facestocks, coatings, varnishes laminates and/or adhesives. As tissue embedding may be performed with large volumes of specimens and may employ numerous cassettes, the identifying of cassettes is an issue.

### SUMMARY OF THE INVENTION

It is an aim of the present disclosure to provide a label for tissue embedding cassette of the type used in pathology, cytology, histology, etc.

Therefore, in accordance with an aspect of the present disclosure, there is provided a label for tissue embedding cassette comprising: a facestock configured to have data on a first surface thereof, and an adhesive layer on a second surface of the facestock, wherein slits are defined in the facestock from an edge thereof, the slits defining at least one tab, the at least one tab configured to be located opposite a female connector in a box of the tissue embedding cassette when the label is adhered to a slanted surface of the tissue embedding cassette; wherein the at least one tab forms a flap movable into the female connector by pressure of a male connector of a lid of the tissue embedding cassette when the male connector penetrates the female connector.

In accordance with yet another aspect of the present disclosure, there is provided a label for tissue embedding cassette comprising: a facestock configured to have data on a first surface thereof, and an adhesive layer on a second surface of the facestock, wherein a notch is defined in the facestock from an edge thereof, the notch configured to be located opposite a female connector in a box of the tissue embedding cassette when the label is adhered to a slanted surface of the tissue embedding cassette; wherein the notch forms a clearance when the male connector penetrates the female connector.

In accordance with yet another aspect of the present disclosure, there is provided kit comprising: a tissue embedding cassette; and a label as described above.

In accordance with yet another aspect of the present disclosure, there is provided method for applying a label onto a tissue embedding cassette, comprising: adhering a label on a slanted surface of a tissue embedding cassette, such that at least one tab of the label covers a female connector of a box of the tissue embedding cassette; and flapping the at least one tab of the label into the female connector by engaging a male connector of a lid of the tissue embedding cassette into the female connector.

In accordance with yet another aspect of the present disclosure, there is provided method for applying a label onto a tissue embedding cassette, comprising: adhering a label on a slanted surface of a tissue embedding cassette, such that a notch of the label surrounds a female connector of a box of the tissue embedding cassette; and engaging a male connector of a lid of the tissue embedding cassette into the female connector, such that the notch defines a clearance.

### BRIEF DESCRIPTION OF THE FIGURES

FIG. 1A is a schematic view of a tissue embedding cassette and label in accordance with an embodiment of the present disclosure;

FIG. 1B is a schematic view of a tissue embedding cassette and label in accordance with another embodiment of the present disclosure;

FIG. 2 is a schematic sectional view of an exemplary construction of the label in accordance with an embodiment of the present disclosure;

FIG. 3A is a schematic face view of the label of FIG. 2 in accordance with a variant of the present disclosure;

FIG. 3B is a schematic face view of the label of FIG. 2 in accordance with another variant of the present disclosure;

FIG. 3C is a schematic face view of the label of FIG. 2 in accordance with another variant of the present disclosure; and

FIG. 3D is a schematic face view of the label of FIG. 2 in accordance with another variant of the present disclosure.

### BRIEF DESCRIPTION OF THE EMBODIMENTS

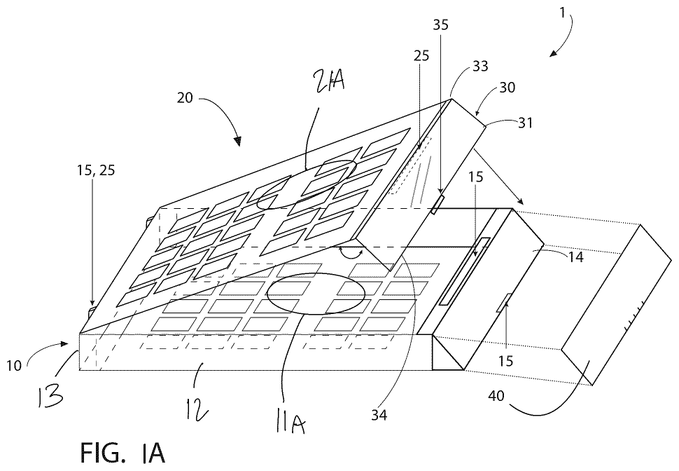

Referring to the drawings, and more particularly to FIGS. 1A and 1B, a schematic tissue embedding cassette is generally shown at 1. The tissue embedding cassette 1 may also be known as a tissue processing cassette, a tissue processing embedding cassette, a slotted cassette, biopsy cassette, micro-biopsy cassette, fine mesh cassette, tissue cassette, among other names. For simplicity, the expression tissue embedding cassette will be used herein for the tissue embedding cassette 1. The tissue embedding cassette 1 is used to accommodate a tissue to be processed. After the dehydrated tissue sample is fixed/processed, it needs to be infiltrated with an embedding agent, such as paraffin wax, paraplast, etc. The embedding agents are available in different hardnesses depending on the plasticizers in the formulation. Tissue samples are then placed into an embedding mold of appropriate size and a molten embedding agent, such as molten paraffin, is poured over it. Then, the bottom part of the cassette 1 is placed over the top of the mold filled with the embedding agent and tissue sample, and more molten embedding agent is poured onto the cassette 1. Consequently, the embedding agent fills the cassette 1 and it gets combined with the mold. Afterwards the tissue embedding molds combined with the cassettes 1 are left to solidify and the embedded tissue combined with the cassette is removed from the mold after the solidification. After the embedding is completed, the block of embedding agent with tissue may be placed in a machine called microtome for sectioning thin slices of the embedded tissue. The slices may get further processing to remove the embedding agent, for instance in a process called deparaffinizing, and for further treatment such as staining of samples for microscopy.

The tissue embedding cassette 1 may be configured to be used in at least some of the steps described above. In an example, the tissue embedding cassette 1 is dimensioned 28.5 mm×41 mm×6.7 mm (1.12″×1.61″×0.26″), but other dimensions are possible. The tissue embedding cassette 1 can generally be described as having a box 10 and a lid 20. The box 10 may be known as the cassette, a receptacle, a cage, etc. The box 10 defines inner cavity A for receiving and accommodating the tissue sample for subsequent embedding. The lid 20, also known as cover, top, etc may open or close access to the inner cavity A. When the lid 20 is locked, connected, snap-fitted, etc onto the box 10, the sample is held captive in the inner cavity A. As described hereinafter, the lid 20 may be unlocked, pivoted and/or separated from the box 10. In an embodiment, the box 10 and lid 20 may be sold separately. It is also possible to use the box 10 without the lid 20.

The box 10 may be a rectangular prism or cuboid, of relatively low profile, in an embodiment, but other shapes are possible. The box 10 may be made of a unitary monoblock body. For example, the box 10 is made of polymers or metals. For example, the box 10 is molded in a high density polymer, such as acetal polymer, polyester, polypropylene, or a thermoplastic or thermoset material. The material is selected for the box 10 to be resistant to histological solvents. In an embodiment, the box 10 may be transparent.

The box 10 may have a base panel 11. The base panel 11 may be generally flat, for example. The base panel 11 may have a matrix of slots 11A, also known as holes. The slots 11A may be rectangular in shape, in accordance with a possibility, but a variety of other shapes are possible as well. The slots 11A allow flow through for good fluid exchange and proper drainage. In an embodiment, the base panel 11 has no slots, or fewer slots. Side walls 12 may project upwardly from either side of the base panel 11, while end walls 13 may project upwardly from either end of the base panel 11. Although the expressions “side” and “end” are used, there may not necessarily be any orientation to the box 10, aside from “up” and “down”. The side walls 12 and the end walls 13 concurrently define the inner cavity A. Internal separations, separators, separator walls may be inside the box 10 for processing multiple tissues simultaneously. The side walls 12 and the end walls 13 may for example be in a rectangular relation with the base panel 11. The side walls 12 and end walls 13 may be provided with slots or drainage openings, though this is not necessary. According to an embodiment, one or both of the end walls 13 has/have a slanted surface 14, though such surface 14 is not necessarily present. The slanted surface 14 may be generally flat, but in an acute angle relative to a bottom plane of the box 10, at any angle up to 90 degrees, and possibly more. The slanted surface 14 may receive information or a label thereon. Its orientation may facilitate identification of the tissue embedding cassette 1, as a user with a top down point of view may more easily the slanted surface 14.

The box 10 may be configured for locking the lid 20 thereon. For instance, connectors 15 may be provided on the top end surfaces of the end walls 13 (as shown) and/or side walls 12. The connectors 15 are shown schematically, but may be any of grooves, tongues, detents, clips, holes, fastener holes, to name a few possibilities. In an embodiment, the connector 15 is a pivot portion, by which a complementary pivot portion of the lid 20 may be pivotally connected. The pivot connection may also be by way of a living hinge, as the box 10 and lid 20 may be comolded for example. The living hinge is one of multiple solutions of complementary connectors. In the various embodiments described herein, the complementary connectors may be snap-fit connections, latches, hinges, clips, catches, interlockings, slidings, grabber clips and/or grooves. In such an arrangement, the lid 20 may be pivoted open.

The lid 20 may be rectangular in an embodiment, to correspond to the shape of the box 10, but other shapes are possible. The lid 20 may be made of a unitary monoblock, for example of polymers or metals. In an embodiment, the lid 20 is made of the same material as the box 10 (e.g., and be transparent as well), such as a molding in a high density polymer (e.g. polyester, polypropylene, biaxially oriented polypropylene, acetal, composite materials, co-extruded materials, etc), to be resistant to histological solvents. Alternatively, the lid 20 may be made of a different material, such as if the lid 20 is integral with a shield or frame 30 described herein. In an embodiment, the box 10 and lid 20 are comolded, with an integrated hinge (e.g., living hinge) or like connector. The lid 20 may have a top panel 21. The top panel 21 may be generally flat, for example. The top panel 21 may or may not have a matrix of slots 21A. The slots 21A may be rectangular in shape, in accordance with a possibility, but a wide variety of other shapes are possible as well. In similar fashion to the slots 11A, the slots 21A allow flow through for good fluid exchange and proper drainage.

Referring to FIG. 1A, the shield 30 may be rigidly attached to the lid 20, or connected to lid 20 via hinge 33, with other connectors such as 35 assisting in clamping the shield 30 to the box 10. In such an embodiment, the box 10 and the lid 20 are hinged to one another by the complementary connectors 15 and 25 (e.g., pivot and hook), at a rear end of the box 10. A bottom edge 34 of the transparent plate body 31 may be provided with a connector 35, to connect to a complementary connector 15 of the box 10. The complementary set of connectors 15 and 35 may be a tab and slot, tongue and groove, etc. In an embodiment, the cooperation of the set of connectors 15 and 35 results in the shield 30 applying a pressure on the slanted surface 14, again to prevent and/or reduce the risk of penetration of liquids between the slanted surface 14 and the shield 30 and in case of penetration of liquids the pressure of the lid 20 physically secures the label 40 in place during the tissue processing.

Referring to FIG. 1B, the frame 30′ may also be rigidly attached to the lid 20, or connected to lid 20 via hinge 33, with other connectors such as 35 assisting in clamping the shield 30 to the box 10. The frame 30 defines a window that may be free of material, for a label to be visible through the window of the frame 30′. The box 10 and the lid 20 are hinged to one another by the complementary connectors 15 and 25 (e.g., pivot and hook), at a rear end of the box 10. A bottom edge 34 of the frame 30′ may be provided with a connector 35, to connect to a complementary connector 15 of the box 10. The complementary set of connectors 15 and 35 may be a tab and slot, tongue and groove, etc. In an embodiment, the cooperation of the set of connectors 15 and 35 results in the frame 30′ applying a pressure on the slanted surface 14. The pressure of the lid 20 and frame 30′ physically secures the label 40 in place during the tissue processing.

Therefore, as can be observed from FIGS. 1A and 1B, the slanted surface 14 of the box 10 may have a connector slot or notch 15 (a.k.a., female connector 15) at or near its bottom edge. Accordingly, a label that is to be adhered to or positioned onto the slanted surface 14 could cover the connector portion 15, and impede the proper securing of the lid 20 to the box 10. If a label is in the way of the connector portion 15, the shield 30 (FIG. 1A) or frame 30′ (FIG. 1B) may not be fully pressed against the slanted surface 14 (with label sandwiched between), as the label may block the connector 35 from penetrating the connection portion 15 (e.g., notch).

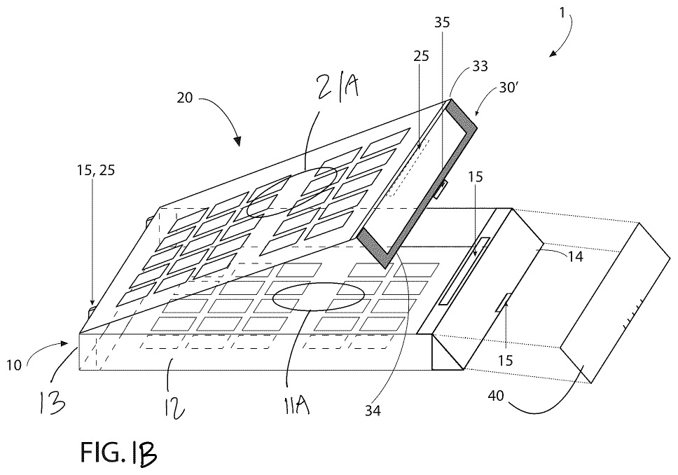

Referring to FIG. 2, the label 40 in accordance with the present disclosure is generally shown at 40. The label 40 may have various layers, all of which may extend from end to end of the label 40, i.e., along a lengthwise direction projecting out of the page of FIG. 2. Facestock 41 is the surface that can accept ink or printing, although the capability of accepting ink is not a requirement. This may include printing using a thermal printer, a thermal-transfer printer, a direct-thermal printer, a laser printer, an inkjet printer, UV-inkjet, water-based inkjet printer, LED printer, UV printer, copier, impact printer, dot-matrix printer, laser-etching printer, flexographic printer, offset printer or a printing press or any other type of printer or device capable of delivering ink on any of the surfaces of the label. This may also include any writing instrument including but not limited to any type of pen, pencil, permanent marker, marking pen, etc. Accordingly, the facestock 41 may incorporate a chromic ink, a thermochromic ink system (such as leuco dye), for example in a layer of coating that is part of the facestock or incorporated in the material of the facestock, for the color to be revealed upon heating. The facestock 41 itself may include one or more layers, including transparent and opaque layers, shielding layer(s), top coatings, inks, varnishes, laminations, wireless communication components such as RFID (Radio Frequency Identification), NFC (Near Field Communication), Bluetooth®and other types of wireless communication tags or a chip, sensor, electronic component, etc. The label 40 can be provided blank or pre-printed, and/or may be with any background color or color indicator such as thermochromic ink, and/or image, and/or information and/or barcode and/or alphanumeric markings, and/or indicia etc. The facestock materials can be made of a polymer, or of a paper such as an impregnated paper (e.g. latex impregnated paper). The facestock material(s) may include but is not limited to polymer(s) such as any type of thermoplastic film, any type of polypropylene (PP) of any density, biaxially oriented polypropylene (BOPP), oriented polypropylene (OPP), biaxially oriented polypropylene terephthalate (BOPET), polyethylene (PE), high density polyethylene (HDPE), low density polyethylene (LDPE), high density polyethylene (HDPE), polyester (PET), nylon (polyamide), polyolefin, polystyrene, vinyl, polyvinyl including polyvinyl chloride (PVC) and polyvinyl fluoride (PVF), acrylate, nylon, satin, polyethylene, polyimide, Tyvek®(flash-spun high density polyethylene fiber based), nanomaterials, composite materials, silicone, silicone rubber, rubber, synthetic rubber, latex, thermoset plastics, plastic extrusion materials, and may also include cloth tissues, woven or non-woven fabrics, foam, metallic foils such as aluminum foil, Velcro®, environmentally friendly materials, degradable and soluble materials including biodegradable and bio compostable materials. The facestock materials include paper and polymer composites or combinations, cloth and polymer composites or combinations, including layers of polymer and paper and/or cloth, such that the paper or cloth is for example laminated with plastic. Embossed, stamped foil, clear, opaque, transparent, translucent and/or reflective materials or any combination thereof may also be used for the facestock 41. The polymers may be thermoplastics or thermo-softening plastics, i.e., plastic polymers that soften or become moldable when heated to a certain threshold temperatures, to solidify upon cooling. The polymers may be thermoset plastics comprising cross-linked polymers to form an irreversible chemical bond and may become non-moldable when heated. The facestock 41 may be selected to have direct thermal printing capacity meaning that an ink system (e.g. leuco-dye) is incorporated inside the facestock 41 or in its top coating. The ink may then be released upon heating the facestock layer 11 such as by a thermal printer or a heat-emitting or heated instrument. The facestock 41 may be for example printed or coated with a non-reversible (e.g., leuco dye) or a reversible chromic or thermochromic ink system which may also be also incorporated inside or applied on the facestock or other constituent of the label 40 such as onto the lamination or inside the adhesive. The use of a combination of printing methods is contemplated. All labels 40 of the present disclosure may or may not accept writing by a pen, pencil, marker or any other instrument for inscribing or manual writing.

In some variants, a thickness of the facestock 41 may be equal to or less than about 12.0 mil. More specifically, the label facestock 41 may have a thickness of between about 0.3 mil and 6.0 mil, and even more specifically, the facestock 41 may have a thickness of between about 0.4 mil and 4.8 mil, or of between about 0.8 mil and 3.5 mil, or still more specifically, of between about 0.9 mil and 3.2 mil. In a variant, the facestock 41 may be transparent or translucent, such that it may be possible to see through it.

An adhesive layer 42 may be coated on the underside of the facestock 41. A support liner or release liner 43 may also be provided, from which the adhesive layer 42 with the facestock 41 can be released. The release liner 43 may be part of the label 40 or may be considered not to be part of the label 40, considering that the label 40 may be commercially available with the release liner 43 but is without the release liner 43 when in use. Hence, in an embodiment, the label 40 does not include the release liner 43, though it may come on the release liner 43. In another embodiment, the label 40 may be linerless. The support liner 43 may have a surface coating (a.k.a., release coating) or any low adherence surface or feature (e.g., silicone, non-silicone release coating, wax, etc.), upon which the adhesive layer 42 is laid, to facilitate the separation of the facestock 41 and adhesive layer 42 from the support liner 43.

The adhesive in the adhesive layer 42 may be any type of adhesive including pressure-sensitive adhesives, and non-limitative examples include a water-based acrylic, an emulsion adhesive, a hot melt including a UV hot melt, UV acrylic, a rubber-based adhesive, a latex-based adhesive, a solvent-based adhesive, a silicon-based adhesive, a UV-curable adhesive, a LED-curable adhesive including a LED-UV-curable adhesive, a cross-linked adhesive, heat activated adhesive, adhesives for cold-stamping or hot-stamping, any combination thereof, etc. Similarly, in a variant, the adhesive can be permanent, while in another scenario, the adhesive can be removable and/or repositionable, allowing repositioning of the label 40 on the surface to be labelled. The adhesive of the adhesive layer 42 can also be a glove-friendly removable adhesive, for example. In an embodiment, the adhesive of the adhesive layer 42 can be water-soluble or water dissolvable, such that the adhesive may be fully dissolved in water or in an aqueous solution within seconds or within a few minutes (e.g., depending on desired characteristic). In an embodiment, the adhesive of the adhesive layer 42 can be environmentally friendly, biodegradable or biocompostable, or any degree of biodegradability or biocompostability. It is noted that any pressure-sensitive adhesive could be used. In some implementations, the adhesive of the adhesive layer 42 can be weakened or even neutralized at one or more locations using any adhesive neutralizing agent such as a varnish, an ink or UV varnish, a UV ink or the like. In some implementations, the adhesive at 42 can be applied according to a certain pattern covering only a portion of the facestock 41 such that a remaining portion of the facestock undersurface is devoid of any adhesive.

The adhesive layer 42 may have a thickness equal to or less than about 5.0 mil. More specifically, the adhesive layer 42 could have a thickness of between about 0.05 mil and 2.0 mil, and even more specifically, the adhesive layer 42 could have a thickness of between about 0.4 mil and 1.5 mil, or of between about 0.6 mil and 1.2 mil, or still more specifically, of between about 0.7 mil and 1.0 mil.

The release liner 43 may be paper based, or polymer based, with contemplated polymers including a polyester (PET), polypropylene, bi-axially oriented polypropylene (BOPP) or any other type of a polymer. For example, the release liner 43 may be a silicone or fluorosilicone coated support on which the adhesive layer 42 is harboured or retained, though other materials can be used, including waxes or other adhesive release coatings, etc, on a substrate. For example, if the support liner 43 is paper based, a low friction coating (e.g., silicone, fluorosilicone, or non-silicone based release coating) may be present to facilitate the peeling off of the facestock 41 and adhesive layer 42 from the support liner 43. Some examples of non-silicone based coatings may include fluoropolymer-based coatings such polytetrafluoroethylene (PTFE) and polyvinylidene fluoride (PVDF); acrylic based release coatings; such as solvent based, water-based, emulsions, dispersions; polyurethane-based release coatings which may be solvent-based or water based; wax-based release coating which may be solvent-based or water based; polymer-blend release coatings which are combinations of different polymers that can be tailored to achieve the desired release performance and compatibility with various adhesives such as blends of acrylics, urethanes, fluoropolymers, etc.

Accordingly, when the release liner 43 is removed, the facestock 41 may be adhered to the slanted surface 14 of the box 10, by the adhesive layer 42. In another embodiment, the release liner 43 may have imaging properties meaning that the manual writing with a pen or a pencil or with any type of impact instrument or impact printer can create a copy of the image on the release liner 43. In this case, when the facestock 41 is removed from the liner 43, the copy of the printed information or the image remains on the release liner 43 similar to carbon-copying. In another embodiment, the label 40 has a paper based facestock and a paper-based release liner 43. In another embodiment, the label 40 has a paper based facestock and a polymeric release liner 43. In another embodiment, the label 40 has a polymeric facestock 41 and a paper-based release liner 43. In another embodiment, the label 40 has a polymeric facestock 41 and a polymeric release liner 43. In another embodiment, the polymeric facestock 41 has an elongation value over 10% in either Machine Direction (MD) or Traverse Direction (TD) prior to breaking as measured according to ASTM D-882A (American Standard Testing Method). In another embodiment, the polymeric facestock 41 has an elongation value over 40% in either Machine Direction (MD) or Traverse Direction (TD) prior to breaking as measured according to ASTM D-882A. In another embodiment, the polymeric facestock 41 has an elongation value over 80% in either Machine Direction (MD) or Traverse Direction (TD) prior to breaking as measured according to ASTM D-882A.

In an embodiment, the label 40 may be blank. However, any type of data may optionally be provided on the label 40, such as symbols, letters and/or numbers. The data may be pre-printed, or may be printed in situ. For example, the data on the label 40 may be a QR code, 1D barcode, 2D barcode, 3D barcode with or without human readable and/or alphanumeric data. Furthermore, any portion of the label 40 may have printing such as a logo, trade name, or any image or graphic alone or together with data or information or any indicia.

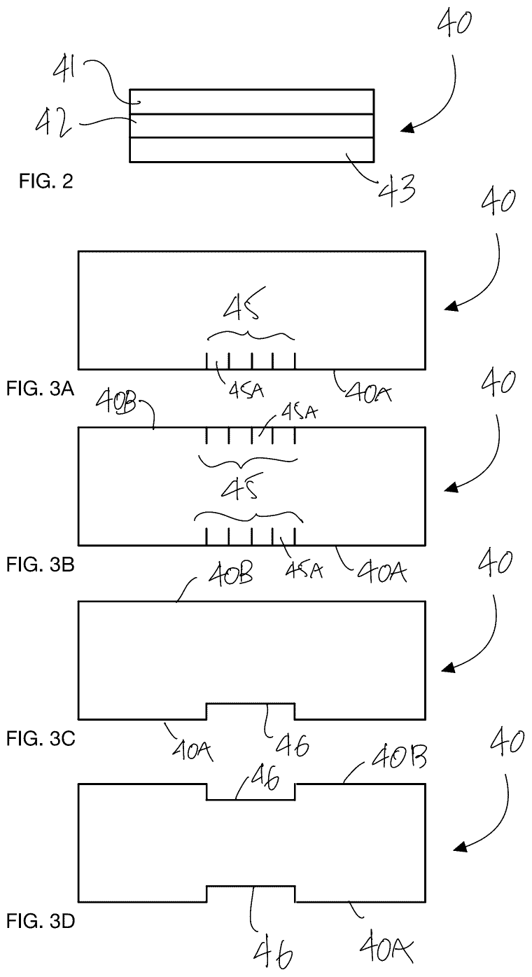

Referring to FIGS. 3A to 3D, the label 40 may be generally rectangular, or have such an elongated shape (e.g., oval). The label 40 may have square corners as shown (straight, 90° angle), but the corners may be rounded, etc. In an embodiment, the radius of the rounded corners is between 0.397 mm ( 1/64″) to 19.05 mm (¾″). In an embodiment, the radius of the rounded corners is between 0.794 mm ( 1/32″) to 3.175 mm (⅛″). The label 40 may be opaque, transparent, translucent, hazy or have any degree of opacity, transparency, translucency or haziness or any combination thereof. The label 40 may have a background color, a chromic ink, thermochromic ink, any coating, varnish or lamination. In some embodiments, the label 40 or any portion thereof may not be opaque.

Referring to FIG. 3A, slits 45 (a.k.a., cuts) may be present in a generally central portion of the label 40, at the bottom edge 40A. Five slits 45 are shown, but there may be more or fewer of such slits 45. The slits 45 penetrate in the material of the facestock 41. Therefore, as a result of the presence of the slits 45, four tabs 45A of material are present, each one of the tabs 45A being between a pair of adjacent slits 45. There may be more or fewer of the tabs 45A. For example, the label 40 could have only two such slits 45 for a single tab 45A.

The location of the tab(s) 45A between slits 45 is based on the location of the connector notch 15 in the slanted surface 14 of the box. When pressure is applied at the location of the slits 45, for example by the male connector 35 of the lid 20, a flapping movement occurs, with the tab(s) 45A penetrating into the female connector 15. Therefore, the tab(s) 45A allow penetration and engagement of the male connector 35 in the female connector 15. In a variant, the presence of multiple ones of the tabs 45A, though optional, may allow for just the appropriate number of tabs 45A to flap inwardly. The tab(s) 45A define a foldable flap(s).

Referring to FIG. 3B, another variant of the label 40 is shown, in which both long edges of the label 40 have slits 45 and tabs 45A, i.e., the bottom edge 40A and the top edge 40B. While expressions “top” and “bottom” are used, these monikers are merely to distinguish the edges 40A and 40B from one another, with the label 40 being reversible.

Referring to FIG. 3C, the label 40 may have a notch 46. The notch 46 is located centrally in the bottom edge 40A of the label 40. The location of the notch 46 and its size is based on the location and size of the connector notch 15 in the slanted surface 14 of the box. When the male connector 35 of the lid 20 is moved into penetrating engagement with the female connector 15, the presence of the notch 46 results in a clearance of the label 40, such that the label 40 is not in the way. Therefore, the notch 46 does not impede the penetration and engagement of the male connector 35 in the female connector 15.

Referring to FIG. 3D, another variant of the label 40 is shown, in which both long edges of the label 40 have notches 46, i.e., the bottom edge 40A and the top edge 40B. While expressions “top” and “bottom” are used, these monikers are merely to distinguish the edges 40A and 40B from one another, with the label 40 being reversible. In a variant, one or both the dimensions of the notch 46 are at most 20% greater than the dimensions of the female connector 15, in an effort to maintain as much printing surface as possible for the label 40. In a variant, a label 40 may have a combination of the slits 45/tab(s) 45A and notch 46. For example, one edge could have slits 45/tab(s) 45A and the other edge could have a notch 46.

A plurality of the labels 40 (or any of FIGS. 3A to 3D) are shown on a common release liner 43, the release liner 43 being in the form of a roll 20. As other embodiments, the release liner 43 may be in the form of a sheet (such as a letter size 8.5″×11″ or A4, or other sheet format) with rows and columns of the label systems 10, or in the form of flat strips with rows of the label systems 10, booklet, fanfold, etc. In an embodiment, when the labels 40 are intended for printing in a laser printer, a LED printer or any other type of printer in a sheet format, the release liner 43 may be resistant to heat without curling when it is passed through such a printer. Such release liners are also known as “layflat” liners. In some cases the layflat liners are thicker than regular release liners, and may be for example up to 7.0 mil in thickness. In an embodiment, similar type sheet configurations can be used for inkjet printers where no significant heat is exerted. The labels 40 may also be available in a kit or in a system with a cassette 1 as described in FIGS. 1A and/or 1B, or parts thereof (e.g., just the box).

Thus, in a variant, the label 40 can be described as being a label for tissue embedding cassette that may have at least a facestock configured to have data on a first surface thereof, and an adhesive layer on a second surface of the facestock, Slits are defined in the facestock from an edge thereof, the slits defining at least one tab, the at least one tab configured to be located opposite a female connector in a box of the tissue embedding cassette when the label is adhered to a slanted surface of the tissue embedding cassette. The at least one tab forms a flap movable into the female connector by pressure of a male connector of a lid of the tissue embedding cassette when the male connector penetrates the female connector.

In another variant, the label 40 can be described as being A label for tissue embedding cassette comprising: a facestock configured to have data on a first surface thereof, and an adhesive layer on a second surface of the facestock. A notch is defined in the facestock from an edge thereof, the notch configured to be located opposite a female connector in a box of the tissue embedding cassette when the label is adhered to a slanted surface of the tissue embedding cassette. The notch forms a clearance when the male connector penetrates the female connector. A kit may include a tissue embedding cassette; and a label as described above.

The label 40 may be applied to the tissue embedding cassette 1 using a method for applying a label onto a tissue embedding cassette, that may include: adhering a label on a slanted surface of a tissue embedding cassette, such that at least one tab of the label covers a female connector of a box of the tissue embedding cassette; and flapping the at least one tab of the label into the female connector by engaging a male connector of a lid of the tissue embedding cassette into the female connector.

The label 40 may be applied to the tissue embedding cassette 1 using a method for applying a label onto a tissue embedding cassette, comprising: adhering a label on a slanted surface of a tissue embedding cassette, such that a notch of the label surrounds a female connector of a box of the tissue embedding cassette; and engaging a male connector of a lid of the tissue embedding cassette into the female connector, such that the notch defines a clearance.

In addition to the embodiments shown herein, the label 40 can be positioned in any orientation on a roll or sheet, such as landscape, portrait, vertical, with any appropriate angle. An orientation can be provided to facilitate automatic peeling from a peeling device or from a robotic device.

1. A label for tissue embedding cassette comprising:
a facestock configured to have data on a first surface thereof, and
an adhesive layer on a second surface of the facestock,
wherein slits are defined in the facestock from an edge thereof, the slits defining at least one tab, the at least one tab configured to be located opposite a female connector in a box of the tissue embedding cassette when the label is adhered to a slanted surface of the tissue embedding cassette;
wherein the at least one tab forms a flap movable into the female connector by pressure of a male connector of a lid of the tissue embedding cassette when the male connector penetrates the female connector.

2. A label for tissue embedding cassette comprising:
a facestock configured to have data on a first surface thereof, and
an adhesive layer on a second surface of the facestock,
wherein a notch is defined in the facestock from an edge thereof, the notch configured to be located opposite a female connector in a box of the tissue embedding cassette when the label is adhered to a slanted surface of the tissue embedding cassette;
wherein the notch forms a clearance when the male connector penetrates the female connector.

3. The label according to claim 1, further including a support liner, the adhesive layer being between the facestock and the support liner, for releasable connection of the facestock to the support liner.

4. The label according to claim 2, further including a support liner, the adhesive layer being between the facestock and the support liner, for releasable connection of the facestock to the support liner.

5. A kit comprising:
a tissue embedding cassette; and
a label according to a claim 1.

6. A method for applying a label onto a tissue embedding cassette, comprising:
adhering a label on a slanted surface of a tissue embedding cassette, such that at least one tab of the label covers a female connector of a box of the tissue embedding cassette; and
flapping the at least one tab of the label into the female connector by engaging a male connector of a lid of the tissue embedding cassette into the female connector.
